(19) United States
(12) Patent Application Publication
(10) Pub. No.: US 2007/0292067 A1
(43) Pub. Date: Dec. 20, 2007

(54) Clamping Arrangement for Securing an Annular Component to a Shaft

(76) Inventors: Suma Ravindra, Bangalore (IN); Bradley D. Faye, Winsted, CT (US); Jaikumar Balasubramanian, Bangalore (IN); Craig R. Etheridge, Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/763,851

(22) Filed: Jun. 15, 2007

Related U.S. Application Data
(63) Continuation-in-part of application No. 11/159,766, filed on Jun. 23, 2005, now abandoned.

(51) Int. Cl. F16C 35/00

(52) U.S. Cl. 384/541

(57) ABSTRACT

An annular component, such as the inner race of an antifriction bearing, fits over a shaft with a slip fit, and then is secured with set screws that bear against an internal band that forms part of the component. The band, in turn, bears against the surface of the shaft. The band has detached ends, which lie midway between the set screws and may be wedge-shaped and radially overlapped, so that when the set screws are turned down, the wedge-shaped ends ride over each other and aid in securing the component to the shaft.

### CROSS-REFERENCE TO RELATED APPLICATIONS

This application is a continuation-in-part of U.S. patent application Ser. No. 11/159,766 filed Jun. 23, 2005, which is incorporated herein by reference.

### STATEMENT REGARDING FEDERALLY SPONSORED RESEARCH

Not applicable.

### BACKGROUND OF THE INVENTION

This invention relates in general to the securement of components carried by shafts and, more particularly, to a clamping arrangement for securing an annular component to a shaft.

Shafts in machinery carry a wide variety of encircling components, which of necessity must be fastened securely to such shafts. For example, where a shaft is supported on antifriction bearings, the inner races of those bearings should be attached in some way to the shaft to prevent the shaft from rotating relative to the race or from displacing axially in the race. If the shaft carries a pulley, it should be attached securely to the shaft to deliver power to or transfer it from the shaft. The same holds true for some other component which may be on the shaft, such as a gear or a collar of some type.

At least insofar as a bearing is concerned, an interference fit will usually prevent rotation between the inner race of the bearing and the shaft and in some instances may serve to fix the axial position of the race on the shaft. But an interference fit renders installation and removal of the bearing difficult and usually requires specialized tools to achieve.

A slip fit, which requires a slight clearance between the shaft and the encircling component, facilitates installation and removal of the component. However, once the encircling component assumes the proper location on the shaft, it needs to be fastened securely to the shaft. Various devices exist for achieving that end, one of the most common being a set screw or multiple set screws. Typically, the set screw threads through a section of the component and bears against the underlying shaft. In so doing it mars the surface of the shaft. The disruption of the shaft surface may be enough to render removal and reinstallation difficult, just as with an interference fit. Moreover, the disruption of the surface could leave any finish on the shaft less effective in serving its purpose, such as inhibiting corrosion. Furthermore, a slip fit will usually leave some eccentricity between the shaft and the encircling component.

### BRIEF DESCRIPTION OF THE SEVERAL VIEWS OF THE DRAWINGS

FIG. 1 is an exploded perspective view, partially broken away and in section, of a clamping arrangement constructed in accordance with and embodying the present invention;

FIG. 2 is a sectional view taken along line 2-2 of FIG. 1;

FIG. 3 is a sectional view taken along line 3-3 of FIG. 2;

FIG. 4 is a sectional view similar to FIG. 2, but of a modified clamping arrangement;

FIG. 5 is a sectional view taken along line 5-5 of FIG. 4; and

FIG. 6 is a sectional view also similar to FIG. 2, but of another modified clamping arrangement.

### DETAILED DESCRIPTION OF THE INVENTION

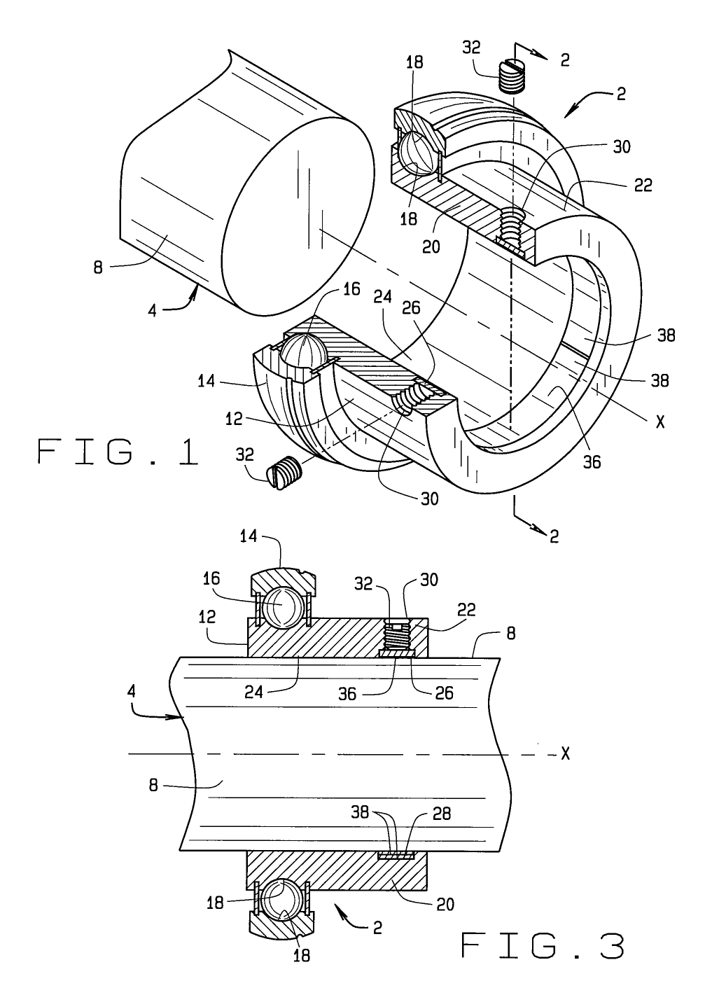

Referring now to the drawings, a bearing 2 (FIG. 1) supports a shaft 4 such that the shaft 4 may rotate about an axis X, which is the axis of the bearing 2 and corresponds closely with the centerline of the shaft 4. The bearing 2 includes an annular encircling component that is secured firmly to the shaft 4. The shaft 4 may carry other encircling components, such as a pulley, and in contrast to the bearing 2, they need not support the shaft 4. In any event, the shaft 2 is formed from plain carbon steel and has a cylindrical surface 8 over which the encircling components fit.

The bearing 2 includes (FIG. 1) an inner race 12, an outer race 14 located around the inner race 12, and rolling elements in the form of balls 16 organized between the inner and outer races 12 and 14. Indeed, the balls 16 contact the races 12 and 14 along raceways 18 in the races 12 and 14. To this end, the two raceways 18, which are presented toward each other, possess arcuate cross sections which generally conform to the balls 16. When the shaft 4 rotates, the balls 16 roll along the raceways 18, yet are confined axially.

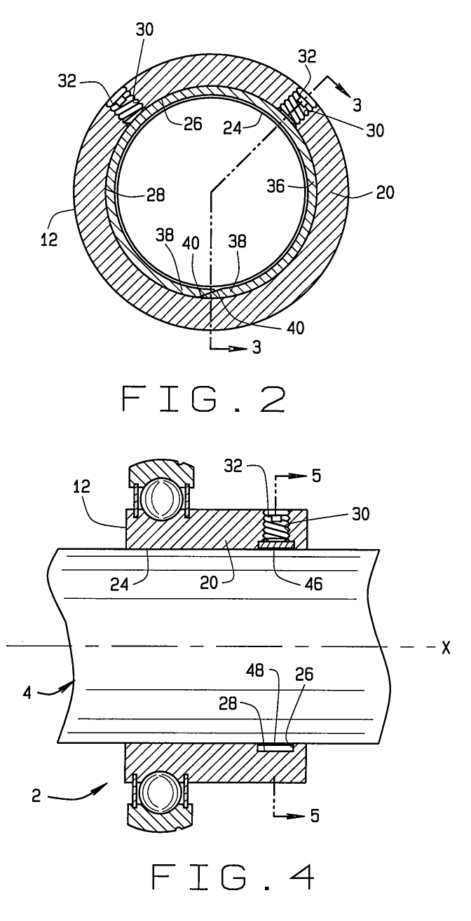

The inner race 12, insofar as the bearing 2 is concerned, constitutes the annular encircling component. It includes (FIGS. 1-3) an annular body 20 formed as an integral piece from low carbon steel. The raceway 18 for the inner race 12 lies between the ends of the annular body 20, there being offset to one side of the raceway 18 a clamping extension 22 at which the inner race 12 is secured firmly to the shaft 4. The annular body 20 contains a through bore 24, the diameter of which is slightly greater than the diameter of the surface 8 on the shaft 4. The differences in diameter should range between 0.0002 and 0.002 in. and should preferably be about 0.001 in. Thus, without other interference, the inner race 12 will fit over the surface 8 on the shaft 4 with a slight clearance—a slip fit so to speak.

Within its clamping section 22 the annular body 20 has an annular groove or channel 26 which opens radially inwardly into the through bore 24. In cross section, the channel 26 is generally rectangular, its back being a cylindrical back surface 28 that lies parallel to the surface of the through bore 24 at a greater diameter. The clamping section 22 also contains two threaded holes 30 which extend radially between the outer surface of the clamping section 22 and the channel 26 into which they open. The spacing between the holes 30 should range between about 30° and 180°, and should preferably be about 90°. The threaded holes 30 contain set screws 32.

The annular body 20 is formed from low carbon steel having a carbon content not exceeding 0.30% by weight. However, it is case carburized and heat treated so as to have a hard case of high carbon steel and more ductile core of low carbon steel. The carbon content of the case at the surfaces of the annular body 20 should be at least 0.07% by weight and the heat treatment should leave it with a hardness of at least 59 HRC. Even so, a portion of the core remains between the cylindrical back surface 28 of the channel 26 and the surrounding exterior surface of the annular body 20. In other words, the hardened case on the annular member 20 should not create a through hardened region at the threaded holes 30. The set screws 32 that thread into those holes 30 are formed from low carbon steel or stainless steel. Preferably each as a cupped inner end that is presented toward the axis X and also nylon patches along its threads to retard backing out of its hole 30 when subjected to vibrations.

In addition to the annular body 20 and the set screws 32, the inner race 12 includes a clamping band 36 that lies within the annular channel 26 of the annular body 20 where it completely encircles the cylindrical surface 8 on the shaft 4. For the most part, the clamping band 36 has a uniform thickness, and that thickness is less than the depth of the annular channel 26. This enables the band 36 to retract fully into the channel 26, so that it does not interfere with the installation of the inner race 12 on the shaft 4. The band 36 is not continuous, but instead has detached ends 38 which overlap radially in the channel 26, yet together will retract fully into the channel 26, just as the much longer intervening section of the band 36. To this end, the ends 38 of the band 36 are wedge shaped, each having an inclined surface 40 that lies oblique to a radius that bisects the overlap and likewise lies oblique to a tangent to the shaft surface 8 at that radius. The two ends 38 overlap and abut along their inclined surfaces 40, but even so the thickness of the band 36 in the region of overlap does not exceed the depth of the annular channel 26. Indeed, the thickness essentially equals the thickness of the remainder of the band 36. However, when the overlapping ends 38 are squeezed together, their combined thickness exceeds the depth of the channel 26, and the band 36 in the region of overlap will project inwardly into the through bore 24, although only slightly. The angle between each inclined surface 40 and a tangent to the cylindrical back surface 28 at a radius bisecting the overlapping ends 38 should range between about 15° and 25° and should preferably be about 20°.

The overlapping ends 38 of the band 36 lie midway between the two set screws 32, preferably along the longer of the two arcs between the screws 32. Thus, when the screws 32 are located 90° apart, the overlapping ends 38 should be about 135° from each screw 32.

The overlapping ends 38 allow the band 36 to contract to a diameter small enough to enable the band 36 to pass through the through bore 24 to the annular channel 26 and then expand into the channel 26. Indeed, the resiliency of the band 36 is such that it expands snugly against the back surface 28 of the annular channel 26. The friction between the expanded band 36 and the back surface 28 prevents the band 36 from rotating in the channel 26, so its overlapping ends 38 remain midway between the set screws 32.

The band 36 is formed from austenitic stainless steel containing at least 0.15% carbon by weight, preferably stainless steel grade 301. Moreover, the stainless steel of the band 36 is subjected to a heat treatment that leaves it with a hardness of at least 40 HRC and preferably 45 HRC, which is fully hardened.

During installation of the bearing 2 over the shaft 4 the clamping band 36 remains against the back surface 28 of the channel 26. In that condition the set screws 32 are backed off to the extent that they are withdrawn fully into their threaded holes 30, and the band 36 is retracted fully into the annular channel 26. Its inside diameter equals or exceeds the diameter of the through bore 24, and it does not project into the through bore 24. Thus, the inner race 12—and the full bearing 2—will easily fit over the shaft 4 with a slip fit. After all, in this condition a clearance exists between the surface 8 of the shaft 4 and the surface of the through bore 24 in the inner race 12, as well as between the surface 8 and the inside surface of the band 36.

Once the inner race 12 reaches the location at which it is to be installed on the shaft 4, the set screws 32 are engaged and turned down, preferably in small increments alternately. The screws 32 drive those segments of the band 36 that are directly beneath them toward and into contact with the surface 8 of the shaft 4. They also drive the overlapping ends 38 together, causing the inclined surface 40 on the one end 38 to slide over the inclined surface 40 on the other end 38. As a consequence, the thickness of the band 36 increases at its overlapping ends 38. Indeed, the increase is great enough to cause the overlapping ends 38 to lodge tightly between back surface 28 of the annular channel 26 and the surface 8 of the shaft 4.

Since the set screws 32 do not bear directly against the shaft 4, they do not mar or otherwise disturb the surface 8 of the shaft 4. Hence, when the set screws 32 are backed off and the band 36 expands to again lie fully within the annular channel 26, the inner race 12 and the bearing 2 of which it is a part slide easily over the cylindrical surface 8 for removal from or repositioning on the shaft 4. The ends of the set screws 32 partially embed in the band 36, when they are tightened. This insures that no relative movement occurs between the stainless steel band 36 and the annular body 20, so that the annular body 20 remains tightly clamped around the shaft 4 while the screws remain tight—and they will remain tight because they cannot over time work into the hardened stainless steel of the band 36 during the operation of the bearing 2.

The presence of the low carbon ductile core between the case hardened back surface 28 of the channel 26 and the case hardened exterior surface out of which the threaded holes 30 open renders the thinnest region of the annular body 20 less susceptible to stress fractures. Yet, owing to the stresses imposed by the set screws 32, this region may experience the greatest stresses.

The bearing 2 may operate in conditions where moisture is present, and were the band 36 formed from plain carbon steel, it would oxidize along with the shaft 4 and in effect unite with the shaft 4 and, for that matter, the annular body 20 as well. Even with the set screws 32 backed off, dislodging the inner race 12 from the shaft 4 would not occur easily, and when removed, could leave the surface 8 of the shaft 4 damaged. Since band 36 is formed from stainless steel, it does not oxidize and does not bond to the surface 8 of the shaft 4 or to the annular body 20 in which it is contained. When the screws 32 are backed off, the band 36 easily releases its grip on the shaft 4 and frees the inner race 12 for removal or repositioning.

Where two machine components that are made from similar metals contact each other and minute repetitive movements occur at the contacting surfaces, fretting corrosion can occur. If the band 36 were made from plain carbon steel, fretting corrosion could well develop between it and the shaft 4, resulting in difficulty removing the bearing 2 from the shaft 4. However, the stainless steel of the annular band 36 prevents fretting corrosion.

The overlapping ends 38 of the band 36 may enhance the clamping power when compared to mere set screws. Furthermore, the expansion radially of the overlapping ends 38 approaches the distance that the set screws 32 drive the segments of the band 36 against which they bear inwardly, so that the inner race 12 more closely approaches concentricity with the shaft 4 than were it installed with set screws alone.

The inner race 12 may have a modified band 46 (FIGS. 4 & 5) provided with detached ends 48 that are separated by an axial slit 50—at least when the band 46 is in the annular channel 26 with the set screws 32 backed away from it. However, when the ends 48 are brought together, to reduce or eliminate the slit 50, the diameter of the band 46 contracts enough to enable the band 46 to pass through the through bore 24 to the channel 26, into which it will expand. Indeed, once aligned with the channel 26, the band 46 expands enough to bear snugly against the back surface 28 of the channel 26 and retain its position in the channel 26. In that position, the band 46 exists entirely within the channel 26 and the slit 50 between its ends lies approximately midway between the set screws 32 on the longest arc between those screws 32. Like the band 36, the band 46 is formed for austenitic stainless steel that has undergone a heat treatment to harden it.

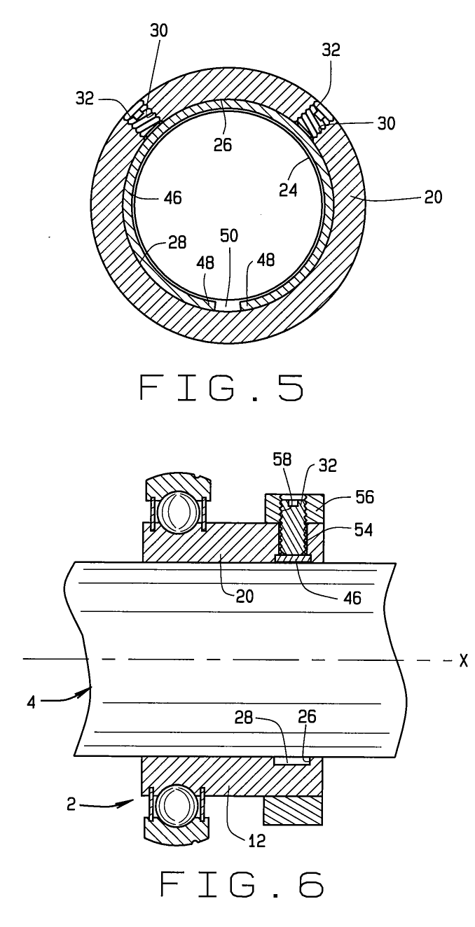

The set screws 32 need not thread into the clamping extension 22 of the annular body 20 itself (FIG. 6). Instead, the clamping section 22 may have smooth radial holes 54 that are slightly larger in diameter than the set screws 32. At those holes 54 a collar 56 encircles the clamping extension 22. It contains threaded holes 58 which align with the smooth holes 54 in the extension 22. The set screws 32 thread into the threaded holes 58 of the collar 56 and extend through the smooth holes 54 in the extension 22. When turned down, they project into the annular channel 26 and bear against the clamping band 36 or the clamping band 46.

The encircling component on the shaft 4 may assume forms other than those of a bearing race. For example, it may be a simple sleeve or collar located around the shaft 4, or a pulley, or gear on the shaft 4. It may also take the form of a race for a different type of antifriction bearing.

The channel 26 in the annular body 20 may assume a slightly eccentric orientation with respect to the through bore 24, thus giving the channel 26 varying depth. Its shallowest region lies generally at the set screws 32, whereas its deepest region accommodates the overlapping ends 38 of the clamping band 36. As a consequence, the ends 38 may have greater thickness.

1. In combination with a shaft having an external surface, an encircling component comprising:
a body having a bore providing an internal surface that surrounds the external surface on the shaft, the body containing a channel which opens inwardly into the bore;
a generally annular band located in the channel, the band being formed from stainless steel; and
a set screw in the body outwardly from the channel and threaded down against the band to clamp the band tightly against the external surface of the shaft,
whereby the encircling component is secured firmly to the shaft.

2. The combination according to claim 1 wherein the band has ends which are detached.

3. The combination according to claim 2 wherein the set screw is one of two set screws.

4. The combination according to claim 3 wherein the ends of the band radially overlap, and the ends of the band where they overlap are wedge-shaped.

5. The combination according to claim 4 wherein the ends of the band are located generally midway between the set screws along an arc between the set screws.

6. The combination according to claim 3 wherein the set screws are threaded into the body.

7. The combination according to claim 1 wherein the ends of the bands are separated by a slit.

8. The combination according to claim 1 wherein the encircling component is an inner race of an antifriction bearing.

9. The combination according to claim 1 wherein the set screw is threaded into the body; wherein the body is formed from low carbon steel and is case hardened along its surface so as to have a hard case and a ductile core; and wherein ductile core exists at the set screw.

10. The combination according to claim 1 wherein the stainless steel of the band is austenitic and is hardened.

11. A machine component for installation on a shaft, said machine component comprising;
a body having a bore and an annular channel that opens into the bore and also having a hole which extends through the body and opens into the channel, the body being formed from plain carbon steel;
a band within the channel where it is capable of assuming a configuration in which it lies entirely within the channel, the band being formed from stainless steel;
a set screw extended through the hole in the body for applying a radially directed force to band.

12. A machine component according to claim 11 wherein the band lies entirely within the channel when the screw is backed away from the band.

13. A machine component according to claim 12 wherein the set screw is one of multiple set screws.

14. A machine component according to claim 12 wherein the set screw is one of two set screws.

15. A machine component according to claim 14 wherein the band has ends that radially overlap within the channel when the set screws are backed away from the band, and the ends of the band, where the ends overlap, are wedge-shaped.

16. A machine component according to claim 13 wherein the band has ends which are separated by a slit when the set screws are backed away from the band, and the slit is located remote from the set screws.

17. A machine component according to claim 11 wherein the set screw is threaded into the body; wherein the body is formed from low carbon steel and is case hardened along its surfaces so as to have a hard case and a ductile core; and wherein ductile core exists at the set screw.

18. The combination according to claim 11 wherein the stainless steel of the band is hardened.

19. A machine component for installation on a shaft, said machine component comprising;
a body having a bore and an annular channel that opens into the bore, and also having a pair of holes which extend through the body and open into the channel;
a band located within the channel where it is capable of assuming a configuration in which it lies entirely within the channel, the band having wedge-shaped ends that are located remote from the holes and radially overlap; and
set screws extended through the holes in the body for applying radially directed forces to band remote from the wedge-shaped ends.

20. A machine component according to claim 15 wherein the overlapping ends of the band are located in an arc generally midway between the set screws.
